(19) United States
(12) Patent Application Publication
(10) Pub. No.: US 2005/0272591 A1
(43) Pub. Date: Dec. 8, 2005

(54) ZrO2-Al2O3 composite ceramic material and production method therefor

(76) Inventors: Masahiro Nawa, Katano-shi (JP); Hideo Nakanishi, Hirakata-shi (JP); Yasuhiko Suehiro, Hirakata-shi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 11/085,039

(22) Filed: Mar. 22, 2005

(30) Foreign Application Priority Data
Mar. 23, 2004 (JP) 2004-085102

(51) Int. Cl. C04B 35/488

(52) U.S. Cl. 501/105; 264/661

(57) ABSTRACT

A ZrO₂—Al₂O₃ composite ceramic material having excellent wear resistance, hardness, strength and toughness is provided. This ceramic material comprises a ZrO₂ phase composed of 90 vol % or more of tetragonal ZrO₂, and preferably containing 10 to 12 mol % of CeO₂ as a stabilizer, and an Al₂O₃ phase. An amount of the Al₂O₃ phase in the ceramic material is in a range of 20 to 70 vol %. The ceramic material comprises composite particles dispersed therein, each of which has a triple nanocomposite structure that an Al₂O₃ grain containing a fine ZrO₂ grain therein is trapped within a ZrO₂ grain.

### BACKGROUND OF THE INVENTION

1. Field of the Invention

The present invention relates to a ZrO₂—Al₂O₃ composite ceramic material with excellent mechanical properties, and a method of producing the same.

2. Disclosure of the Prior Art

As compared with metal and plastic materials, ceramic materials demonstrate excellent hardness, wear resistance, heat resistance and corrosion resistance. As for practical use of the ceramic materials in various application fields, for example, biomaterial parts such as artificial joint and artificial tooth, medical equipments, cutting tools such as drill and surgical knife, mechanical parts for automobile, airplane and space craft used under severe conditions, it is desired to develop a ceramic material having further improved mechanical strength and toughness in a high level. In recent years, a zirconia (ZrO₂)-alumina (Al₂O₃) composite ceramic material has received attention as a potential candidate of the ceramic material.

For example, Japanese patent Early publication [kokai] No. 5-246760 discloses a ZrO₂-based composite ceramic sintered body comprising a matrix phase of tetragonal ZrO₂ grains containing 5 to 30 mol % of CeO₂ and a dispersion phase of fine grains of at least one of selected from the group consisting of Al₂O₃, SiC, Si₃N₄ and B₄C, which are dispersed within the ZrO₂ grains and at grain boundaries of the matrix phase. By the presence of the dispersion phase, a grain growth of the matrix phase is prevented and a fine grained structure of the matrix phase is obtained, so that significant strengthening is achieved mainly due to a reduction in flaw size of the fracture origin.

In addition, U.S. Pat. No. 5,728,636 discloses a ZrO₂-based ceramic material having high mechanical strength and toughness, which comprises a tetragonal ZrO₂ phase of ZrO₂ grains having an average grain size of 5 μm or less, and containing 8 to 12 mol % of CeO₂ and 0.05 to 4 mol % of TiO₂ as a stabilizer, and an Al₂O₃ phase of Al₂O₃ grains having an average grain size of 2 μm or less. In this ceramic material, the Al₂O₃ grains are dispersed within the ZrO₂ grains at a dispersion ratio of 2% or more, which is defined as a ratio of the number of the Al₂O₃ grains dispersed in the ZrO₂ grains relative to the number of the entire Al₂O₃ grains dispersed in the ceramic material. In addition, by using the combination of CeO₂ and TiO₂ as the stabilizer, the grain growth of the ZrO₂ grains can be enhanced moderately, so that parts of the Al₂O₃ grains are effectively dispersed within the ZrO₂ grains, and a critical stress of a stress induced transformation from the tetragonal ZrO₂ to monoclinic ZrO₂ is increased.

By the way, as one potential approach for improving wear resistance and hardness of this kind of the ceramic material, it is proposed to increase the additive amount of Al₂O₃. However, such an increase of the Al₂O₃ amount generally leads to reductions in mechanical strength and toughness. In above cases, a preferred amount of Al₂O₃ in the composite ceramic sintered body or the ceramic material is in a range of 0.5 to 50 vol %. When the Al₂O₃ amount exceeds 50 vol %, Al₂O₃ becomes the matrix phase, so that it is difficult to maintain a strengthening mechanism based on a stress induced phase transformation of ZrO₂. Consequently, considerable reductions in mechanical strength and toughness may occur.

Thus, the previous ZrO₂—Al₂O₃ composite ceramic materials still have a problem to be solved for providing excellent wear resistance and hardness without causing reductions in mechanical strength and toughness under a larger amount of Al₂O₃.

### SUMMARY OF THE INVENTION

Therefore, a primary concern of the present invention is to provide a ZrO₂—Al₂O₃ composite ceramic material having increased wear resistance and hardness, while maintaining a good balance between mechanical strength and toughness, under a larger amount of Al₂O₃ than heretofore.

That is, the ZrO₂—Al₂O₃ composite ceramic material of the present invention comprises a ZrO₂ phase composed of 90 vol % or more of tetragonal ZrO₂, and an Al₂O₃ phase, wherein an amount of the Al₂O₃ phase in the composite ceramic material is in a range of 20 to 70 vol %, and the composite ceramic material comprises composite grains dispersed therein, each of which has a structure that an Al₂O₃ grain having a fine ZrO₂ grain therein is trapped within a ZrO₂ grain.

In the above composite ceramic material, it is preferred that the ZrO₂ phase contains 10 to 12 mol % of CeO₂ as a stabilizer. In addition, it is preferred that a ratio of the number of Al₂O₃ grains, each of which exists in said composite particle and has the fine ZrO₂ grain therein, relative to the number of the entire Al₂O₃ grains dispersed in the composite ceramic material is 0.3% or more. This ratio defines preferred amounts of the composite particles in the composite ceramic material of the present invention.

In addition, it is preferred that a first dispersion ratio of the number of Al₂O₃ grains dispersed within ZrO₂ grains relative to the number of the entire Al₂O₃ grains dispersed in the composite ceramic material is 1.5% or more. Specifically, the first dispersion ratio defines a ratio of a total of the number of Al₂O₃ grains of the composite particles, each of which has the fine ZrO₂ grain therein and is trapped within the ZrO₂ grain, and the number of Al₂O₃ grains, each of which does not have the fine ZrO₂ grain therein and is trapped within the ZrO₂ grain, relative to the entire Al₂O₃ grains dispersed in the composite ceramic material. When the first dispersion ratio is 1.5% or more, the composite ceramic material can be more effectively reinforced by the Al₂O₃ grains dispersed within the ZrO₂ grains. Consequently, the mechanical properties of the composite ceramic material of the present invention can be further improved.

In addition, it is preferred that a second dispersion ratio of the number of ZrO₂ grains dispersed in Al₂O₃ grains relative to the number of the entire ZrO₂ grains dispersed in the composite ceramic material is 4% or more. Specifically, the second dispersion ratio defines a ratio of a total of the number of fine ZrO₂ grains, which are trapped within the Al₂O₃ grains constructing the composite particles, and the number of ZrO₂ grains, which are trapped within the Al₂O₃ grains not constructing the composite particles, relative to the number of the entire ZrO₂ grains dispersed in the composite ceramic material. When the second dispersion ratio is 4% or more, it is possible to increase an amount of zirconia toughened alumina (ZTA) formed by the fine tetragonal ZrO₂ grains trapped within the Al₂O₃ grains, as described later. Consequently, the composite ceramic material of the present invention demonstrates excellent mechanical properties with a higher degree of reliability.

In the present invention, the improvement in mechanical properties of the composite ceramic material has been achieved by aggressively dispersing the composite particles in the composite ceramic material to consequently increase the formation amount of zirconia toughened alumina (ZTA) therein.

A further concern of the present invention is to provide a method of producing the ZrO₂—Al₂O₃ composite ceramic material described above. That is, this method comprises the steps of:
mixing a first powder for providing said ZrO₂ phase with a second powder for providing said Al₂O₃ phase such that an amount of the Al₂O₃ phase in the composite ceramic material is in a range of 20 to 70 vol %;
molding a resultant mixture in a desired shape to obtain a green compact; and
sintering the green compact in an oxygen-containing atmosphere, so that the composite ceramic material comprises composite particles dispersed therein, each of which has a structure that an Al₂O₃ grain having a fine ZrO₂ grain therein is trapped within a ZrO₂ grain.

As a preferred preparation process of the second powder in the above method, it comprises the step of adding a ZrO₂ powder to at least one selected from a θ-Al₂O₃ powder and a γ-Al₂O₃ powder having a specific surface of 50 to 400 m²/g to obtain a mixed powder. In addition, it is preferred that the preparation process comprises the steps of adding a ZrO₂ powder to one of an aqueous solution of an aluminum salt and an organic solution of an aluminum alkoxide, hydrolyzing a resultant mixture to obtain a precipitate, and drying the precipitate. Alternatively, it is preferred that the preparation process comprises the steps of adding an aqueous solution of a zirconium salt to one of an aqueous solution of an aluminum salt and an organic solution of an aluminum alkoxide, hydrolyzing a resultant mixture to obtain a precipitate, and drying the precipitate. In theses preparation processes, it is preferred to calcine the mixed powder or the precipitate in an oxygen containing atmosphere at a temperature of 800° C. to 1300° C.

From the viewpoint of more efficiently dispersing the composite particles in the composite ceramic material of the present invention, it is particularly preferred that that the second powder is largely composed of α-Al₂O₃ particles having an average particle size of 0.3 μm or less, each of which has a fine ZrO₂ particle therein. In this case, it is possible to promote the formation of the composite particles during the sintering step, and consequently increase the amount of zirconia toughened alumina (ZTA) in the composite ceramic material.

Without wishing to be bound by theory, it is presently believed that the remarkable improvement of mechanical properties in the present invention results from the following mechanism. As described above, the ZrO₂—Al₂O₃ composite ceramic material of the present invention is characterized by the composite particles dispersed therein, each of which has the structure that the Al₂O₃ grain having the fine (tetragonal) ZrO₂ grain therein is trapped within the (larger) ZrO₂ grain. Since the fine (tetragonal) ZrO₂ grain trapped within the Al₂O₃ grain provides the zirconia toughened alumina (ZTA), the toughness of the Al₂O₃ grain is remarkably improved by the presence of the fine ZrO₂ grain. When such a toughness-improved Al₂O₃ grain is trapped within the (larger) ZrO₂ grain, sub-grain boundaries are formed within the ZrO₂ grain. The formation of the sub-grain boundaries plays a role in dividing the (larger) ZrO₂ grain, incorporating the toughness-improved Al₂O₃ grain therein, into imaginary more finer sized grains.

In addition, a residual stress field generated within the (larger) ZrO₂ grain increases a critical stress required for causing a stress induced phase transformation from tetragonal ZrO₂ to monoclinic ZrO₂. Furthermore, in the present invention, the dispersion of the composite particles (In the present specification, the structure of the composite particle is named as “a triple nanocomposite structure”.) remarkably reduces the average grain size of ZrO₂ and Al₂O₃ grains constructing the composite ceramic material. Thus, according to such a unique structural control at nanometer levels, it is possible to provide the ZrO₂—Al₂O₃ composite ceramic material having excellent wear resistance and hardness, while maintaining the good balance between mechanical strength and toughness, under a larger amount, i.e., 40 to 70 vol % of Al₂O₃ in the composite ceramic material.

These and further purposes and advantages of the present invention will be clearly understood from the following detail explanation of the invention.

### BRIEF EXPLANATION OF THE DRAWING

FIG. 1 is a SEM photograph showing a composite particle dispersed in a ZrO₂—Al₂O₃ composite ceramic material of the present invention.

### DETAIL EXPLANATION OF THE INVENTION

The ZrO₂ phase of the ZrO₂—Al₂O₃ composite ceramic material of the present invention is composed of 90 vol % or more of tetragonal ZrO₂. To obtain such a large amount of tetragonal ZrO₂, it is preferred that the ZrO₂ phase contains 10 to 12 mol % of CeO₂ as a stabilizer. When the CeO₂ amount is less than 10 mol %, an amount of monoclinic ZrO₂ relatively increases, so that cracks may easily occurs in the composite ceramic material. On the other hand, when the CeO₂ amount exceeds 12 mol %, cubic ZrO₂ of a high-temperature stable phase begins to appear, so that there is a fear that the mechanical strength and toughness can not be sufficiently improved by the stress induced phase transformation of tetragonal ZrO₂ to monoclinic ZrO₂. Preferably, the zirconia phase is composed of 90 vol % or more of tetragonal ZrO₂ and the balance of monoclinic ZrO₂.

The composite ceramic material of the present invention is essential to contain 20 to 70 vol %, and preferably 40 to 60 vol % of the Al₂O₃ phase. When the Al₂O₃ amount is less than 20 vol %, the wear resistance and the mechanical strength of the composite ceramic material can not be sufficiently improved. On the other hand, when the Al₂O₃ amount exceeds 70 vol %, considerable reductions in mechanical strength and toughness occur. When the Al₂O₃ amount is in the range of 40 to 60 vol %, it is possible to provide a high-reliability ceramic material having good balance between the mechanical strength and toughness in a high level.

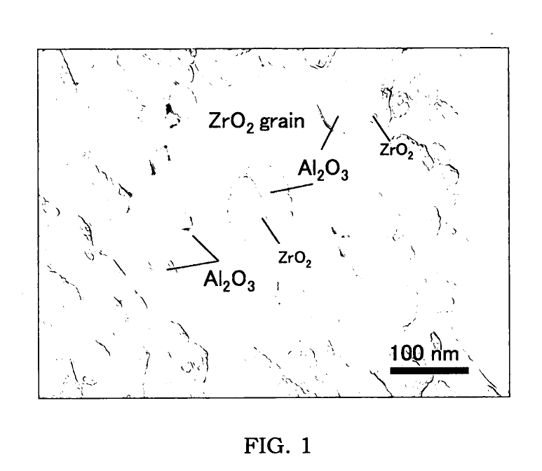

The most important feature of the composite ceramic material of the present invention is to aggressively disperse the composite particles to the composite ceramic material, each of which has the structure that the Al₂O₃ grain containing a fine (tetragonal) ZrO₂ grain therein is trapped within a ZrO₂ grain, as shown in FIG. 1.

In the present invention, it is preferred that a ratio of the number of the Al₂O₃ grains each existing in the composite particle and having the fine ZrO₂ grain therein relative to the number of the entire Al₂O₃ grains dispersed in the composite ceramic material is 0.3% or more. When this ratio is less than 0.3%, the formation amount of the zirconia toughened alumina (ZTA) in the composite ceramic material decreases, so that there is a fear that the effect of improving the mechanical strength and toughness is not sufficiently obtained as increasing Al₂O₃ content. In other words, as this ratio is larger than 0.3%, a much higher improvements of both mechanical strength and toughness of the composite ceramic material can be obtained.

It is also preferred that a first dispersion ratio of the number of Al₂O₃ grains dispersed in the ZrO₂ grains relative to the number of the entire Al₂O₃ grains dispersed in the composite ceramic material is 1.5% or more. When the first dispersion ratio is less than 1.5%, an effect of dividing the ZrO₂ grains into more finer sized grains by the formation of sub-grain boundaries may become insufficient, so that a reduction in strength easily occurs as increasing Al₂O₃ content. An upper limit of the first dispersion ratio is not restricted. In a theoretical sense, as the first dispersion ratio increases, the mechanical properties of the composite ceramic material can be further improved. The number of Al₂O₃ grains each existing in the composite particle is included in the number of the Al₂O₃ grains dispersed in the ZrO₂ grains.

It is preferred that a second dispersion ratio of the number of ZrO₂ grains dispersed in the Al₂O₃ grains relative to the number of the entire ZrO₂ grains dispersed in the composite ceramic material is 4% or more. When the second dispersion ratio is less than 4%, the formation amount of the zirconia toughened alumina (ZTA) decreases, so that the effect of improving the mechanical properties of the composite ceramic material may become insufficient. In particular, when the second dispersion ratio is less than 4% in the presence of a large amount of Al₂O₃ content, a reduction in strength easily occurs. An upper limit of the second dispersion ratio is not restricted. In a theoretical sense, as the second dispersion ratio increases, the mechanical properties of the composite ceramic material can be further improved.

The size of the fine ZrO₂ grain of the composite particle is not restricted on the assumption that the fine ZrO₂ grain can be trapped within the Al₂O₃ grain. For example, it is preferred that fine tetragonal ZrO₂ grains having an average grain size of several ten nanometers are trapped within the Al₂O₃ grains. The number of the fine ZrO₂ grains each trapped within the Al₂O₃ grain of the composite particle is included in the number of the ZrO₂ grains dispersed in the Al₂O₃ grains.

It is preferred that the Al₂O₃ grains of the composite ceramic material has an average grain size of 0.1 to 0.5 μm. When the average grain size exceeds 0.5 μm, it becomes difficult to disperse the Al₂O₃ grains within the ZrO₂ grains at the above first dispersion ratio. On the other hand, when the average grain size is less than 0.1 μm, it is difficult to obtain a highly dense sintered body of the composite ceramic material by pressureless sintering.

The size of the ZrO₂ grain of the composite particle is determined such that the Al₂O₃ grain having the fine ZrO₂ grain therein is trapped within the ZrO₂ grain. However, when the size of the ZrO₂ grain is excessively large, it may lead to a reduction in strength of the composite ceramic material. From this viewpoint, it is preferred that an average grain size of the ZrO₂ grains of the composite ceramic material is in a range of 0.1 to 1 μm. This average grain size is based on the ZrO₂ grains other than the fine ZrO₂ grains trapped within the Al₂O₃ grains. When the average grain size exceeds 1 μm, reductions in wear resistance and mechanical strength may occur. On the other hand, when the average grain size is less than 0.1 μm, it becomes difficult to obtain a highly dense sintered body of the composite ceramic material by pressureless sintering.

By the way, in the case of a conventional composite ceramic material with a simply mixed structure of ZrO₂ and Al₂O₃ grains having an average grain size of several micron levels, when the Al₂O₃ amount exceeds 30 vol %, the toughening mechanism based on the stress induced phase transformation of tetragonal ZrO₂ to monoclinic ZrO₂ is not a dominant factor of the composite ceramic material, so that there is a tendency that the mechanical strength and toughness gradually decrease. In addition, when the Al₂O₃ amount exceeds 50 vol %, it means that the matrix phase of the composite ceramic material is provided by the Al₂O₃ phase. This leads to a considerable deterioration of the mechanical properties of the conventional composite ceramic material.

According to the ZrO₂—Al₂O₃ composite ceramic material of the present invention, in which the composite particles having the triple nanocomposite structure are dispersed, the fine ZrO₂ grains each trapped within the Al₂O₃ grain and the Al₂O₃ grains each trapped within the ZrO₂ grain contribute to promote piling up dislocations and form the sub-grain boundaries within the crystal grains, so that the wear resistance and mechanical strength of the composite ceramic material can be remarkably improved. In particular, when the Al₂O₃ amount is in the range of 40 to 60 vol %, fine tetragonal ZrO₂ grains are uniformly dispersed in the Al₂O₃ grains to form the zirconia toughened alumina (ZTA) structure, so that the Al₂O₃ grains are remarkably reinforced. In other words, even when the Al₂O₃ amount exceeds 50 vol %, high mechanical strength and toughness can be maintained by the formation of a fine crystal-grain structure effectively reinforced by the tetragonal ZrO₂ grains. From these reasons, the ZrO₂—Al₂O₃ composite ceramic material of the present invention obtained under the Al₂O₃ content larger than 50 vol % where the matrix phase is the Al₂O₃ phase exhibits excellent mechanical strength and toughness substantially equal to the former ZrO₂—Al₂O₃ ceramic material where the matrix phase is the ZrO₂ phase.

Without wishing to be bound by theory, it is presently believed that the mechanical properties of the composite ceramic material of the present invention are improved by the following mechanism. That is, when the composite particles are dispersed in the composite ceramic material, each of which has the structure that the Al₂O₃ grain containing the fine tetragonal ZrO₂ grain therein is trapped within the tetragonal ZrO₂ grain, a residual stress field is locally generated around each of the fine tetragonal ZrO₂ grains within the Al₂O₃ grains and around each of the Al₂O₃ grains within the tetragonal ZrO₂ grains by a difference in thermal expansion coefficient between Al₂O₃ and ZrO₂ during a cooling procedure after sintering. By the influence of the residual stress field, lots of dislocations easily occur within the respective crystal grains. The dislocations are then piled up with each other, and finally the sub-grain boundaries are formed within the Al₂O₃ and ZrO₂ grains, respectively. The sub-grain boundaries provide the finer-grained structure, which has the capability of increasing a critical stress required for causing the stress-induced phase transformation from the tetragonal ZrO₂ to the monoclinic ZrO₂. As a result, the composite ceramic material of the present invention demonstrates excellent wear resistance and hardness as well as high mechanical strength and toughness.

Referring to the SEM photograph of FIG. 1, the structure of the composite ceramic material of the present invention is more concretely explained. This SEM photograph shows that the above-described composite particle exists in a uniformly mixed structure of normal tetragonal ZrO₂ grains not having Al₂O₃ grains therein, and normal α-Al₂O₃ grains not having ZrO₂ grains therein. In addition, it shows that an Al₂O₃ grain containing a fine ZrO₂ grain therein and Al₂O₃ grains not containing the fine ZrO₂ grain therein are dispersed within the large ZrO₂ grain constructing this composite particle. Moreover, it shows that an Al₂O₃ grain containing a fine ZrO₂ grain therein other than the composite particle exists in the composite ceramic material. The number of fine ZrO₂ grains in the single Al₂O₃ grain and the number of Al₂O₃ grains in the single ZrO₂ grain are not restricted. For example, a plurality of fine ZrO₂ grains may be trapped in the single Al₂O₃ grain, or a plurality of Al₂O₃ grains may be trapped in the single ZrO₂ grain.

As a preferred embodiment of the present invention, the zirconia phase may contain another stabilizer such as MgO, CaO, TiO₂ and/or Y₂O₃ in addition to CeO₂. For example, it is preferred to use 0.01 to 1 mol % of TiO₂ and/or 0.01 to 0.5 mol % of CaO with respect to the total amount of the zirconia phase in addition to 10 to 12 mol % of CeO₂. In this case, the grain growth of the zirconia phase is enhanced to a moderate degree by the addition of TiO₂, so that Al₂O₃ grains can be easily dispersed within the ZrO₂ grains. In addition, it is possible to increase a critical stress of the stress induced phase transformation. When the additive amount of TiO₂ is less than 0.01 mol %, the effect of enhancing the grain growth of the zirconia phase may be not obtained sufficiently. On the other hand, when the additive amount of TiO₂ exceeds 1 mol %, abnormal grain growth of the zirconia phase easily occurs, so that the mechanical strength and the wear resistance of the composite ceramic material may deteriorate.

On the other hand, the addition of CaO prevents the abnormal grain growth of the zirconia phase to improve the balance between the mechanical strength and toughness. In particular, it is effective to obtain the composite ceramic material having excellent wear resistance and mechanical strength. When the additive amount of CaO is less than 0.01 mol %, the effect of preventing the abnormal grain growth of the zirconia phase may be not obtained sufficiently. On the other hand, when the additive amount of CaO exceeds 0.5 mol %, cubic zirconia beings to appear in the zirconia phase, so that it becomes difficult to obtain the zirconia phase composed of 90 vol % or more of tetragonal ZrO₂. The generation of cubic zirconia easily leads to an increase in average grain size of the zirconia phase. In such a case, deterioration in mechanical strength, toughness and wear resistance may occur. The zirconia phase may contain a small amount of impurities. For example, it is desired that the amount of the impurities is 0.5 mol % or less with respect to the total amount of the zirconia phase.

The composite ceramic material of the present invention is preferably used in applications requiring excellent wear resistance expected by increasing the Al₂O₃ content, while maintaining mechanical strength and toughness substantially equal to the previous ZrO₂—Al₂O₃ ceramic materials. For example, it is preferred to use the composite ceramic material of the present invention for an artificial joint described in the international patent application WO02/11780. That is, when a joint portion of the artificial joint is provided by a sliding contact between the composite ceramic material and polyethylene, it is possible to reduce a wear amount of polyethylene. In addition, when the joint portion of the artificial joint is formed by a sliding contact between the composite ceramic materials, particularly improved wear resistance can be achieved. Thus, by use of the composite ceramic material of the present invention, it is possible to obtain the artificial joint having the capability of stably providing a smooth joint motion for an extended time period under severe conditions in a living body.

Next, a method of producing the ZrO₂—Al₂O₃ composite ceramic material of the present invention of the present invention is explained. The present method comprises the steps of mixing a first power for providing the ZrO₂ phase with a second powder for providing the Al₂O₃ phase such that an amount of the Al₂O₃ phase in the composite ceramic material is in a range of 20 to 70 vol %, molding a resultant mixture in a desired shape to obtain a green compact, and sintering the green compact at a sintering temperature in an oxygen-containing atmosphere, so that the composite ceramic material comprises composite particles dispersed therein, each of which has a structure that an Al₂O₃ grain containing a fine ZrO₂ grain therein is trapped within a ZrO₂ grain.

To obtain the ZrO₂ phase composed of 90 vol % or more of tetragonal ZrO₂, it is preferred that the first powder is prepared such that the ZrO₂ phase contains 10 to 12 mol % of CeO₂ as a stabilizer. In addition, as the first powder, it is preferred to use a tetragonal ZrO₂ powder containing a required amount of TiO₂ and/or CaO in addition to CeO₂. A preparation process of the first powder is not restricted. For example, the following process is recommended.

That is, a cerium containing compound such as cerium salts is added to an aqueous solution of a zirconium salt. If necessary, an aqueous solution of a titanium salt and/or a calcium salt, or an organic solution of a titanium or calcium alkoxide as a titanium containing compound or a calcium containing compound may be added. Then, hydrolysis is performed by adding an alkali aqueous solution such as aqueous ammonia to a resultant mixture to obtain a precipitate. The precipitate is dried, calcined in the oxygen-containing atmosphere, e.g., in the air, and then pulverized by means of wet ball milling to obtain the tetragonal ZrO₂ powder having a desired particle distribution.

In the case of using the tetragonal ZrO₂ powder, it is preferred that the ZrO₂ powder has a specific surface area of 10 to 20 m²/g to obtain the green compact of a sufficient green density. Such a green compact can be easily sintered by pressureless sintering. When the specific surface area is less than 10 m²/g, it becomes difficult to obtain the ZrO₂ phase having an average grain size of 1 μm or less after sintering. On the other hand, when the specific surface area exceeds 20 m²/g, the bulk density considerably decreases, so that handling of the first powder becomes difficult. As a result, there is a fear that the green compact can not be densely sintered by pressureless sintering.

In the present invention, to uniformly disperse the composite particles consisting of the triple nanocomposite structure in the composite ceramic material, it is particularly preferred to use a composite powder comprising Al₂O₃ particles each containing a fine ZrO₂ particle therein as the second powder. For example, a required amount of the first powder is mixed with an Al₂O₃ powder to obtain a mixed powder, and then a resultant mixed powder is calcined in an oxygen containing atmosphere at a temperature of 800° C. to 1300° C., and preferably 1000° C. to 1200° C. to obtain the composite powder. In this case, it is preferred that the Al₂O₃ powder is at least one selected from a θ-Al₂O₃ powder and a γ-Al₂O₃ powder having a specific surface area of 50 to 400 m²/g. The specific surface area of this Al₂O₃ powder is much greater than the specific surface of the first powder. In other words, since the Al₂O₃ powder used to prepare the composite powder is much finer than the first powder, the above-described mixed powder comprises ZrO₂ particles surrounded with ultra-fine Al₂O₃ particles.

Next, a phase transformation of θ-Al₂O₃ and/or γ-Al₂O₃ of the mixed powder to α-Al₂O₃ occurs during the calcining procedure. At this time, the ZrO₂ particles in the mixed powder are trapped within α-Al₂O₃ particles each having an increased particle size caused by the phase transformation. The thus obtained composite powder is excellent in moldability as compared with the case of using the θ-Al₂O₃ or γ-Al₂O₃ powder. In addition, there is an advantage that the average grain size of the Al₂O₃ particle dispersed in the composite ceramic material can be easily controlled in the range of 0.1 to 0.5 μm.

It is preferred that the composite powder obtained by the above preparation process is mainly composed of α-Al₂O₃ particles having an average grain size of 0.3 μm or less, each of which has the fine ZrO₂ particle therein. However, an amount of α-Al₂O₃ in the composite powder is not restricted. That is, it is enough that a part of θ-A₂O₃ and/or γ-Al₂O₃ is transformed to α-Al₂O₃ by the calcining procedure, and allowed to be mixed condition of θ-A₂O₃ and/or γ-Al₂O₃ and α-Al₂O₃.

The preparation process of the second powder is not restricted. For example, a ZrO₂ powder is added to an aqueous solution of an aluminum salt or an organic solution of an aluminum alkoxide. A resultant mixture is hydrolyzed to obtain a precipitate, and then the precipitate is dried. The dried precipitate is calcined in an oxygen containing atmosphere at a temperature of from 800° C. to 1300° C., and then pulverized by means of wet ball milling to obtain the second powder having a desired particle distribution. In the above method, an aqueous solution of a zirconium salt may be used in stead of the ZrO₂ powder.

In the case of preparing the composite powder as the second powder, a mixing ratio of Al₂O₃ and ZrO₂ is not restricted. To efficiently obtain the α-Al₂O₃ particles each containing a fine ZrO₂ particle therein, it is preferred that a volume ratio of Al₂O₃: ZrO₂ in the composite powder is in a range of 95:5 to 50:50. When the value of ZrO₂ in this volume ratio is less than 5, it is difficult to obtain sufficient amounts of the α-Al₂O₃ particles each containing a fine ZrO₂ particle therein by the calcining procedure. Consequently, the formation amount of the composite particles in the composite ceramic material decreases. On the other hand, when the value of ZrO₂ in this volume ratio is more than 50, an agglomeration of the ZrO₂ particles may occur. When the above volume ratio is within the range of 90:10 to 60:40, it is possible to more efficiently obtain the α-Al₂O₃ particles each containing a fine ZrO₂ particle therein, thereby providing a high-quality composite powder suitable for producing the composite ceramic material of the present invention.

If necessary, a HIP treatment may be performed in an oxygen-containing atmosphere after sintering. To obtain effects of the HIP treatment at the maximum, it is preferred that the sintered body of the composite ceramic material obtained by the pressureless sintering has a relative density of 95% or more. A concentration of oxygen in the oxygen-containing atmosphere is not restricted. A mixture gas of oxygen and an inert gas such as argon may be used. In this case, it is preferred that the concentration of oxygen is approximately 5 vol % or more with respect to a total volume of the mixture gas.

### EXAMPLES

The present invention is explained below according to preferred examples. The present invention is not limited to these Examples.

### Examples 1 to 6 and Comparative Examples 1 to 3

A ZrO₂—Al₂O₃ composite ceramic material of each of Examples 1 to 6 and Comparative Examples 1 to 3 was produced by the following method. That is, as the first component for providing a ZrO₂ phase of the composite ceramic material, a tetragonal ZrO₂ powder having a specific surface area of 15 m²/g and containing 11 mol % of CeO₂, 0.05 mol % of TiO₂, and 0.16 mol % of CaO was used. On the other hand, as a second component for providing an Al₂O₃ phase of the composite ceramic material, a composite powder comprised of a γ-Al₂O₃ powder having a specific surface area of 300 m²/g and a part of the tetragonal ZrO₂ powder was used. A mixture ratio by volume of the γ-Al₂O₃ powder and the tetragonal ZrO₂ powder is 70:30.

The composite powder was prepared by the following procedures. That is, required amounts of the γ-Al₂O₃ powder and the tetragonal ZrO₂ powder were ball-milled in an ethanol solvent for 24 hours, and then dried to obtain a mixed powder. Subsequently, the mixed powder was calcined at 1000° C. in the air for 2 hours. The thus obtained calcined powder was further ball-milled in an ethanol solvent for 24 hours, and then dried to obtain the composite powder.

The remaining tetragonal ZrO₂ powder was mixed with the composite powder such that an Al₂O₃ amount in the composite ceramic material is in a range of 10 to 80 vol %, as listed in Table 1. A resultant mixture was ball-milled in an ethanol solvent for 24 hours, and then dried to obtain a powder for sintering. In Comparative Example 1, the Al₂O₃ content is zero.

The obtained powder for sintering was molded at the pressure of 10 MPa by uniaxial pressing to obtain a disk-shaped green compact having a diameter of about 68 mm. After a CIP (cold isostatic pressing) treatment was performed to the green compact at the pressure of 147 MPa, the green compact was sintered at the sintering temperature of 1440° C. for 3 hours in the air by pressureless sintering to obtain a sintering body.

With respect to each of Examples 1 to 6 and Comparative Examples 1 to 3, the sintered body has a relative density of more than 99%. By X-ray diffraction analysis, it was confirmed that the ZrO₂ phase of the respective sintered body is composed of 90 vol % or more of tetragonal ZrO₂ and the balance of monoclinic ZrO₂. In addition, by SEM (scanning electron microscope) and TEM (transmission electron microscope) observations, it was confirmed that the sintered body of each of Examples 1 to 6 and Comparative Examples 2 and 3 comprises composite particles dispersed therein, each of which has a triple nanocomposite structure that an Al₂O₃ grain containing a fine ZrO₂ grain therein is trapped within a ZrO₂ grain.

In addition, a first dispersion ratio (W1), which is defined as a ratio of the number of the Al₂O₃ grains dispersed within the ZrO₂ grains relative to the number of the entire Al₂O₃ grains dispersed in the composite ceramic material, second dispersion ratio (W2), which is defined as a ratio of the number of the ZrO₂ grains dispersed within the Al₂O₃ grains relative to the number of the entire ZrO₂ grains dispersed in the composite ceramic material, and a third dispersion ratio (W3), which is defined as a ratio of the number of Al₂O₃ grains each existing in the composite particle and containing the fine ZrO₂ grain therein relative to the number of the entire Al₂O₃ grains dispersed in the composite ceramic material, were listed in Table 2.

The first to third dispersion ratios (W1, W2; W3) were determined by the following method. First, a sample for observation was prepared by polishing the sintered body and performing a heat treatment to the polished surface. Then, the SEM observation of the sample or the TEM observation of the sintered body was performed to count the number (S1) of entire Al₂O₃ grains existing within a view field, the number (S2) of the entire ZrO₂ grains existing within the same view field, the number (n1) of Al₂O₃ grains dispersed within the ZrO₂ grains in the same view field, the number (n2) of the ZrO₂ grains dispersed within the Al₂O₃ grains in the same view field, and the number (n3) of Al₂O₃ grains, each of which exists in the composite particle and contains the fine ZrO₂ grain therein, in the same view field. By substituting these values to the following equations, those dispersion ratios were calculated. Results are shown in Tables 2.
W1 [%]=(n1/S1)×100,
W2 [%]=(n2/S2)×100.
W3 [%]=(n3/S1)×100

TABLE 1

| | | | | | Average Grain | |
|---|---|---|---|---|---|---|
| | ZrO₂ phase (mol %) | | | Al₂O_{3 phase} | Size (μm) | |
| | CeO₂ | TiO₂ | CaO | (vol %) | ZrO₂ | Al₂O₃ |
| Comparative | 11 | 0.05 | 0.16 | 0 | 2.50 | — |
| Example 1 | | | | | | |
| Comparative | 11 | 0.05 | 0.16 | 10 | 1.35 | 0.23 |
| Example 2 | | | | | | |
| Example 1 | 11 | 0.05 | 0.16 | 20 | 0.43 | 0.24 |
| Example 2 | 11 | 0.05 | 0.16 | 30 | 0.23 | 0.26 |
| Example 3 | 11 | 0.05 | 0.16 | 40 | 0.21 | 0.27 |
| Example 4 | 11 | 0.05 | 0.16 | 50 | 0.19 | 0.27 |
| Example 5 | 11 | 0.05 | 0.16 | 60 | 0.18 | 0.28 |
| Example 6 | 11 | 0.05 | 0.16 | 70 | 0.17 | 0.29 |
| Comparative | 11 | 0.05 | 0.16 | 80 | 0.16 | 0.30 |
| Example 3 | | | | | | |

TABLE 2

| | Bending | Fracture | Vickers | | First | Second | Third |
|---|---|---|---|---|---|---|---|
| | Strength | Toughness | Hardness | Wear factor | Dispersion | Dispersion | Dispersion |
| | (MPa) | (MPa · m^{1/2}) | (GPa) | (mm³/Nm × 10⁻⁷) | Ratio (%) | Ratio (%) | Ratio (%) |
| Comparative | 750 | 18.0 | 8.5 | 230 | — | — | — |
| Example 1 | | | | | | | |
| Comparative | 1080 | 17.2 | 9.7 | 48.2 | 3.5 | 6.5 | 1.4 |
| Example 2 | | | | | | | |
| Example 1 | 1260 | 16.7 | 10.8 | 0.135 | 3.4 | 6.4 | 1.4 |
| Example 2 | 1380 | 15.8 | 12.0 | 0.048 | 3.3 | 6.3 | 1.3 |
| Example 3 | 1430 | 14.5 | 13.1 | 0.036 | 3.1 | 6.1 | 1.2 |
| Example 4 | 1410 | 13.2 | 14.3 | 0.028 | 2.8 | 5.9 | 1.1 |
| Example 5 | 1340 | 11.8 | 15.4 | 0.051 | 2.3 | 5.6 | 0.9 |
| Example 6 | 1220 | 10.2 | 16.6 | 0.074 | 1.7 | 5.1 | 0.7 |
| Comparative | 900 | 7.9 | 17.7 | 2.65 | 0.9 | 4.5 | 0.4 |
| Example 3 | | | | | | | |

In addition, with respect to each of Examples 1 to 6 and Comparative Examples 1 to 3, average grain sizes of ZrO₂ grains and Al₂O₃ grains of the sintered body were measured by the TEM/SEM observation. To evaluate mechanical properties of the composite ceramic material, test specimens having the dimensions of 4 mm×3 mm×40 mm were prepared from the sintered body, and then 3-point bending strength and fracture toughness were measured at room temperature. The fracture toughness was measured by the IF method. Results are listed in Tables 1 and 2.

Moreover, to evaluate wear resistance of the composite ceramic material, a pin-on-disc test was performed in the presence of distilled water as a lubricant. The pin and the disc are made of the same composite ceramic material. The pin is provided with a cylinder solid having a diameter of 5 mm and a length of 15 mm, and a circular cone having an apical angle of 30° and formed on a top of the cylinder solid. The top end of the circular cone has a flat mirror area with a diameter of 1.5 mm, which is used as a sliding surface. A surface roughness of this sliding surface is smaller than 0.005 μm Ra.

On the other hand, the disc has a diameter of 50 mm and a thickness of 8 mm. A sliding surface of the disc to be made contact with the pin is a mirror polished surface having a surface roughness smaller than 0.005 μm Ra. After the pin was placed on a circumference having a radius of 22 mm from the disc center on the disc, the pin-on-disc test was performed at a disc rotational speed of 60 mm/sec. A load applied to the pin is 60N, and a sliding distance is constant (25 km). Since the diameter of the top end of the pin is 1.5 mm, an initial friction pressure on the top end of the pin is 33 MPa. The pin-on-disc test was repeated three times under the same condition. An average value of the tests was adopted as data.

A reduction in weight of the pin was measured after the test, and a wear factor (Wf) was calculated by the following equation.
Wf=(W1−W2)/P·L·ρ
Where,
Wf: wear factor (mm3/Nm)
W1: dry weight (g) of pin before test
W2: dry weight (g) of pin after test
P: load (N)
L: sliding distance (m)
ρ: density (g/mm3) of test specimen

In addition, Vickers hardness of the composite ceramic material was measured. Measurement results of the wear factor and the hardness are shown in Table 2.

As understood from results of Tables 1 and 2, the sintered bodies of Examples 1 to 6 containing 20 to 70 vol % of Al₂O₃ have the first dispersion ratio (W1) greater than 1.5%, second dispersion ration (W2) greater than 4%, and the third dispersion ratio (W3) greater than 0.3%. In addition, these sintered bodies demonstrate excellent mechanical properties of a bending strength greater than 1200 MPa and a fracture toughness higher than 10.0 MPa·m^{1/2}.

On the other hand, since the sintered body of Comparative Example 1 does not contain the Al₂O₃ phase, it has excellent fracture toughness. However, the bending strength of the sintered body is considerably low. The sintered body of Comparative Example 2 has excellent fracture toughness and the first to third dispersion ratios substantially equal to the sintered body of Example 1. However, the average grain size (=1.35 μm) of the ZrO₂ grains of Comparative Example 2 is much greater than the average grain size (=0.43 μm) of the ZrO₂ grains of Example 1. This suggests that the grain growth of the ZrO₂ grains can not be sufficiently inhibited by using such a small amount of Al₂O₃. As a result, the sintered body of Comparative Example 2 has a relatively low mechanical strength, and a tendency of increasing variations in mechanical properties. Thus, it is difficult to provide the composite ceramic material that is excellent in both of strength and toughness. With respect to the sintered body of Comparative Example 3, since the excessive amount of Al₂O₃ was used, both of strength and toughness considerably lowered. In addition, the number of the Al₂O₃ grains dispersed in the ZrO₂ grains, i.e., the first dispersion ratio (W1) is extremely low. This suggests that the composite particles can not be efficiently dispersed in the composite ceramic material in the case of using such a large amount of Al₂O₃.

As described above, the concern of the present invention is to provide the ceramic material having excellent wear resistance and hardness, while maintaining high strength and toughness under the larger amount of Al₂O₃ than heretofore. The results of Table 2 show that both of wear resistance and hardness can be highly improved when the Al₂O₃ content is in the range of 20 to 70 vol %. On the contrary, the sintered body of Comparative Example 2 shows a deterioration in wear resistance due to the deficiency of Al₂O₃ and the increase in average grain size of the ZrO₂ grains. In addition, the sintered body of Comparative Example 3 shows poor mechanical strength and toughness as well as the deterioration in wear resistance due to the excessive amount of Al₂O₃ in the composite ceramic material.

### Examples 7 to 21

A ZrO₂—Al₂O₃ composite ceramic materials of each of Examples 7 to 21 was produced by the following method. That is, as listed in table 3, a tetragonal ZrO₂ powder having a specific surface area of 15 m²/g and containing a CeO₂ amount of 10 to 12 mol % or containing the CeO₂ amount of 10 to 12 mol %, TiO₂ amount of 0.02 to 1 mol %, and a CaO amount of 0.02 to 0.5 mol % was used as the first component for providing a ZrO₂ phase of the composite ceramic material. On the other hand, as a second component for providing an Al₂O₃ phase of the composite ceramic material, a composite powder prepared by the following process was used. That is, a part of the above-described tetragonal ZrO₂ powder was added to a hydrochloric acid solution of aluminum chloride (AlCl₃) such that a mixture ratio by volume of Al₂O₃: ZrO₂ is 70:30. Next, an aqueous solution of sodium hydroxide was added to a resultant mixed solution, and hydrolyzed to obtain a precipitate. The precipitate was washed with water, and then dried. Next, the dried precipitate was calcined at 1000° C. in the air for 2 hours. The thus obtained calcined powder was ball-milled in an ethanol solvent for 24 hours, and then dried to obtain the composite powder.

The remaining tetragonal ZrO₂ powder was mixed with the composite powder such that an Al₂O₃ amount in the composite ceramic material is 40 vol %. A resultant mixture was ball-milled in an ethanol solvent for 24 hours, and then dried to obtain a powder for sintering. The powder for sintering was molded into a required shape by uniaxial pressing, and then sintered by pressureless sintering to obtain a sintered body, as in the case of Example 1.

With respect to each of Examples 7 to 21, the sintered body has a relative density of more than 99%. By X-ray diffraction analysis, it was confirmed that the ZrO₂ phase of the respective sintered body is composed of 90 vol % or more of tetragonal ZrO₂ and the balance of monoclinic ZrO₂. In addition, by SEM (scanning electron microscope) and TEM (transmission electron microscope) observations, it was confirmed that the sintered body of each of Examples 7 to 21 comprises composite particles dispersed therein, each of which has a triple nanocomposite structure that an Al₂O₃ grain containing a fine ZrO₂ grain therein is trapped within a ZrO₂ grain. As in the case of Example 1, the first to third dispersion ratios were determined with respect to each of Examples 7 to 21. Results are shown in Table 4.

TABLE 3

| | | | | | Average Grain | |
|---|---|---|---|---|---|---|
| | ZrO₂ phase (mol %) | | | Al₂O_{3 phase} | Size (μm) | |
| | CeO₂ | TiO₂ | CaO | (vol %) | ZrO₂ | Al₂O₃ |
| Example 7 | 10 | 0.00 | 0.00 | 40 | 0.21 | 0.20 |
| Example 8 | 10 | 0.05 | 0.03 | 40 | 0.24 | 0.22 |
| Example 9 | 10 | 0.30 | 0.15 | 40 | 0.33 | 0.25 |
| Example 10 | 10 | 0.70 | 0.35 | 40 | 0.45 | 0.28 |
| Example 11 | 10 | 1.00 | 0.50 | 40 | 0.50 | 0.30 |
| Example 12 | 11 | 0 | 0 | 40 | 0.21 | 0.20 |
| Example 13 | 11 | 0.03 | 0.02 | 40 | 0.23 | 0.21 |
| Example 14 | 11 | 0.20 | 0.10 | 40 | 0.29 | 0.24 |
| Example 15 | 11 | 0.60 | 0.30 | 40 | 0.43 | 0.28 |
| Example 16 | 11 | 0.90 | 0.45 | 40 | 0.48 | 0.29 |
| Example 17 | 12 | 0 | 0 | 40 | 0.21 | 0.20 |
| Example 18 | 12 | 0.02 | 0.01 | 40 | 0.22 | 0.21 |
| Example 19 | 12 | 0.10 | 0.05 | 40 | 0.26 | 0.23 |
| Example 20 | 12 | 0.50 | 0.25 | 40 | 0.40 | 0.27 |
| Example 21 | 12 | 0.80 | 0.40 | 40 | 0.47 | 0.29 |

TABLE 4

| | Bending | Fracture | First | Second | Third |
|---|---|---|---|---|---|
| | Strength | Toughness | Dispersion | Dispersion | Dispersion |
| | (MPa) | (MPa · m^{1/2}) | Ratio (%) | Ratio (%) | Ratio (%) |
| Example 7 | 1100 | 18.0 | 2.3 | 4.8 | 1.3 |
| Example 8 | 1350 | 17.6 | 2.8 | 5.9 | 1.6 |
| Example 9 | 1260 | 17.4 | 3.0 | 6.4 | 1.7 |
| Example 10 | 1240 | 17.2 | 3.1 | 6.6 | 1.8 |
| Example 11 | 1210 | 17.1 | 3.3 | 7.0 | 1.9 |
| Example 12 | 1220 | 14.8 | 2.3 | 5.0 | 1.3 |
| Example 13 | 1420 | 14.5 | 2.8 | 5.9 | 1.6 |
| Example 14 | 1410 | 14.3 | 2.9 | 6.1 | 1.6 |
| Example 15 | 1310 | 14.1 | 3.0 | 6.4 | 1.7 |
| Example 16 | 1290 | 14.0 | 3.2 | 6.8 | 1.8 |
| Example 17 | 1410 | 11.0 | 2.3 | 4.8 | 1.3 |
| Example 18 | 1570 | 10.7 | 2.8 | 5.9 | 1.6 |
| Example 19 | 1540 | 10.6 | 2.9 | 6.1 | 1.7 |
| Example 20 | 1380 | 10.5 | 3.0 | 6.4 | 1.7 |
| Example 21 | 1360 | 10.4 | 3.2 | 6.8 | 1.8 |

In addition, with respect to each of Examples 7 to 21, average grain sizes of the ZrO₂ grains and the Al₂O₃ grains of the sintered body were measured by the SEM/TEM observation. The average grain size of the ZrO₂ grains is in a range of 0.2 to 0.5 μm, and the average grain size of the Al₂O₃ grains is 0.3 μm or less. To evaluate mechanical properties of the composite ceramic material, test specimens having dimensions of 4 mm×3 mm×40 mm were prepared from the sintered body, and 3-point bending strength and fracture toughness were measured at room temperature. The fracture toughness was measured by the IF method. Results are shown in Tables 3 and 4.

The results of Tables 3 and 4 suggest that the bending strength can be further improved by using slight amounts of TiO₂ and CaO in addition to CeO₂ as the stabilizer, without deteriorating the fracture toughness.

### Examples 22 to 27

A ZrO₂—Al₂O₃ composite ceramic materials of each of Examples 22 to 27 was produced by the following method. That is, as the first component for providing a ZrO₂ phase of the composite ceramic material, a tetragonal ZrO₂ powder having a specific surface of 15 m²/g and containing 11 mol % of CeO₂, 0.05 mol % of TiO₂, and 0.13 mol % of CaO was used. On the other hand, as a second component for providing an Al₂O₃ phase of the composite ceramic material, a composite powder comprised of a O-Al₂O₃ powder having a specific surface of 100 m²/g and a part of the above-described tetragonal ZrO₂ powder was used. A mixture ratio by volume of the O-Al₂O₃ powder and the tetragonal ZrO₂ powder was changed in a range of 95:5 to 50:50, as shown in Table 5.

The composite powder was prepared by the following procedures. That is, required amounts of the θ-Al₂O₃ powder and the above-described tetragonal ZrO₂ powder were ball-milled in an ethanol solvent for 24 hours, and then dried to obtain a mixed powder. Subsequently, the mixed powder was calcined at 1000° C. in the air for 2 hours. The thus obtained calcined powder was further ball-milled in an ethanol solvent for 24 hours, and then dried to obtain the composite powder.

The remaining tetragonal ZrO₂ powder was mixed with the composite powder such that an Al₂O₃ content in the composite ceramic material is 50 vol %. A resultant mixture was ball-milled in an ethanol solvent for 24 hours, and the dried to obtain a powder for sintering. The powder for sintering was molded into a required shape by uniaxial pressing, and then sintered by pressureless sintering to obtain a sintered body, as in the case of Example 1.

With respect to each of Examples 22 to 27, the sintered body has a relative density of more than 99%. By X-ray diffraction analysis, it was confirmed that the ZrO₂ phase of the respective sintered body is composed of 90 vol % or more of tetragonal ZrO₂ and the balance of monoclinic ZrO₂. In addition, by SEM (scanning electron microscope) and TEM (transmission electron microscope) observations, it was confirmed that the sintered body of each of Examples 22 to 27 comprises composite particles dispersed therein, each of which has a triple nanocomposite structure that an Al₂O₃ grain containing a fine ZrO₂ grain therein is trapped within a ZrO₂ grain. As in the case of Example 1, the first to third dispersion ratios were determined with respect to each of Examples 22 to 27. Results are shown in Table 6.

In addition, with respect to each of Examples 22 to 27, average grain sizes of ZrO₂ grains and Al₂O₃ grains of the sintered body were measured by the SEM/TEM observation. The average grain size of the ZrO₂ grains is in a range of 0.2 to 0.3 μm, and the average grain size of the Al₂O₃ grains is 0.3 μm or less. To evaluate mechanical properties of the composite ceramic material, test specimens having dimensions of 4 mm×3 mm×40 mm were prepared from the sintered body, and 3-point bending strength and fracture toughness were measured at room temperature. The fracture toughness was measured by the IF method. Results are shown in Tables 5 and 6.

The results of Tables 5 and 6 suggest that when the mixture ratio of Al₂O₃ and tetragonal ZrO₂ in the composite powder is in the range of 95:5 to 50:50, and particularly 90:10 to 60:40, the ZrO₂ grains can be efficiently trapped within the Al₂O₃ grains. In addition, the number of the Al₂O₃ grains each containing the ZrO₂ grain therein, i.e., the second dispersion ratio (W2) can be increased by use of the composite powder with the above mixture ratio. Furthermore, by selecting a suitable mixture ratio of Al₂O₃ and tetragonal ZrO₂ in the composite powder, it is possible to obtain the composite ceramic material having a further improved strength, while keeping the toughness constant.

As understood from the above Examples, the ZrO₂—Al₂O₃ composite ceramic material of the present invention is characterized by comprising composite particles dispersed therein, each of which has a triple nanocomposite structure that an Al₂O₃ grain containing a fine ZrO₂ grain therein is trapped within a larger ZrO₂ grain. The formation of this nanocomposite structure provides further improvements in wear resistance, hardness, strength and toughness of the ZrO₂—Al₂O₃ ceramic material under a larger amount of Al₂O₃ than heretofore. Therefore, the composite ceramic material of the present invention is expected to be preferably utilized in various application fields, for example, parts for industrial machine such as ferrule for optical fiber connector, bearings and dies, cutting tools such as scissor and saw blade, stationery goods, chemical goods such as mechanical seal and milling media, goods for sport, medical equipments such as surgical knife, biomaterial parts such as artificial joint, artificial bone, artificial dental root, abutment and crown.

TABLE 5

| | | | | | Average Grain | |
|---|---|---|---|---|---|---|
| | ZrO₂ phase (mol %) | | | Al₂O₃ phase | Size (μm) | |
| | CeO₂ | TiO₂ | CaO | vol % (Al₂O₃:ZrO₂) | ZrO₂ | Al₂O₃ |
| Example 22 | 11 | 0.05 | 0.13 | 50 (95:5) | 0.25 | 0.30 |
| Example 23 | 11 | 0.05 | 0.13 | 50 (90:10) | 0.23 | 0.28 |
| Example 24 | 11 | 0.05 | 0.13 | 50 (80:20) | 0.22 | 0.27 |
| Example 25 | 11 | 0.05 | 0.13 | 50 (70:30) | 0.21 | 0.26 |
| Example 26 | 11 | 0.05 | 0.13 | 50 (60:40) | 0.22 | 0.27 |
| Example 27 | 11 | 0.05 | 0.13 | 50 (50:50) | 0.23 | 0.28 |

TABLE 6

| | Bending | Fracture | First | Second | Third |
|---|---|---|---|---|---|
| | Strength | Toughness | Dispersion | Dispersion | Dispersion |
| | (MPa) | (MPa · m^{1/2}) | Ratio (%) | Ratio (%) | Ratio (%) |
| Example 22 | 1230 | 13.0 | 2.9 | 4.2 | 0.3 |
| Example 23 | 1340 | 13.1 | 3.0 | 5.1 | 0.6 |
| Example 24 | 1430 | 13.3 | 3.1 | 6.1 | 1.2 |
| Example 25 | 1430 | 13.3 | 3.2 | 6.2 | 1.8 |
| Example 26 | 1380 | 13.2 | 3.2 | 5.8 | 2.4 |
| Example 27 | 1260 | 12.9 | 3.1 | 4.9 | 2.8 |

1. A ZrO₂—Al₂O₃ composite ceramic material comprising a ZrO₂ phase composed of 90 vol % or more of tetragonal ZrO₂, and an Al₂O₃ phase, wherein an amount of said Al₂O₃ phase in the composite ceramic material is in a range of 20 to 70 vol %, and the composite ceramic material comprises composite grains dispersed therein, each of which has a structure that an Al₂O₃ grain containing a fine ZrO₂ grain therein is trapped within a ZrO₂ grain.

2. The composite ceramic material as set forth in claim 1, wherein said ZrO₂ phase contains 10 to 12 mol % of CeO₂ as a stabilizer.

3. The composite ceramic material as set forth in claim 1, wherein a ratio of the number of Al₂O₃ grains, each of which exists in said composite particle and has the fine ZrO₂ grain therein, relative to the number of the entire Al₂O₃ grains dispersed in the composite ceramic material is 0.3% or more.

4. The composite ceramic material as set forth in claim 1, wherein a first dispersion ratio of the number of Al₂O₃ grains dispersed in ZrO₂ grains relative to the number of the entire Al₂O₃ grains dispersed in the composite ceramic material is 1.5% or more.

5. The composite ceramic material as set forth in claim 1, wherein a second dispersion ratio of the number of ZrO₂ grains dispersed in Al₂O₃ grains relative to the number of the entire ZrO₂ grains dispersed in the composite ceramic material is 4% or more.

6. The composite ceramic material as set forth in claim 1, wherein an average grain size of said ZrO₂ phase is in a range of 0.1 to 1 μm, and an average grain size of said Al₂O₃ phase is in a range of 0.1 to 0.5 μm.

7. A method of producing a ZrO₂—Al₂O₃ composite ceramic material comprising a ZrO₂ phase composed of 90 vol % or more of tetragonal ZrO₂, and an Al₂O₃ phase, the method comprising the steps of:
mixing a first powder for providing said ZrO₂ phase with a second powder for providing said Al₂O₃ phase such that an amount of said Al₂O₃ phase in the composite ceramic material is in a range of 20 to 70 vol %;
molding a resultant mixture in a desired shape to obtain a green compact; and
sintering said green compact in an oxygen-containing atmosphere, so that the composite ceramic material comprises composite particles dispersed therein, each of which has a structure that an Al₂O₃ grain containing a fine ZrO₂ grain therein is trapped within a ZrO₂ grain.

8. The method as set forth in claim 7, wherein the first powder comprises a ZrO₂ powder containing 10 to 12 mol % of CeO₂ as a stabilizer.

9. The method as set forth in claim 7, wherein the second powder contains Al₂O₃ particles each having a fine ZrO₂ particle therein.

10. The method as set forth in claim 7, wherein a preparation process of the second powder comprises the step of adding a ZrO₂ powder to at least one selected from a θ-Al₂O₃ powder and a γ-Al₂O₃ powder having a specific surface area of 50 to 400 m²/g to obtain a mixed powder.

11. The method as set forth in claim 7, wherein a preparation process of the second powder comprises the steps of adding a ZrO₂ powder to one of an aqueous solution of an aluminum salt and an organic solution of an aluminum alkoxide, hydrolyzing a resultant mixture to obtain a precipitate, and drying the precipitate.

12. The method as set forth in claim 7, wherein a preparation process of the second powder comprises the steps of adding an aqueous solution of a zirconium salt to one of an aqueous solution of an aluminum salt and an organic solution of an aluminum alkoxide, hydrolyzing a resultant mixture to obtain a precipitate, and drying the precipitate.

13. The method as set forth in claim 10, comprising the step of calcining the mixed powder in an oxygen containing atmosphere at a temperature of 800° C. to 1300° C.

14. The method as set forth in claim 11, comprising the step of calcining the precipitate in an oxygen containing atmosphere at a temperature of from 800° C. to 1300° C.

15. The method as set forth in claim 12, comprising the step of calcining the precipitate in an oxygen containing atmosphere at a temperature of from 800° C. to 1300° C.

16. The method as set forth in claim 7, wherein the second powder is mainly composed of α-Al₂O₃ particles having an average particle size of 0.3 μm or less, each of which has a fine ZrO₂ particle therein.

17. The method as set forth in claim 9, wherein a volume ratio of Al₂O₃: ZrO₂ in the second powder is in a range of 95:5 to 50:50.
